(19) United States
(12) Patent Application Publication
(10) Pub. No.: US 2010/0129263 A1
(43) Pub. Date: May 27, 2010

(54) Method for Supporting A Driver Using Fragrance Emissions

(76) Inventors: Toshiya Arakawa, Tokyo (JP); Miyuki Kobayashi, Tokyo (JP); Noriyoshi Matsuo, Tokyo (JP)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/694,587

(22) Filed: Jan. 27, 2010

Related U.S. Application Data
(62) Division of application No. 11/771,449, filed on Jun. 29, 2007.

(30) Foreign Application Priority Data
Jul. 4, 2006 (JP) 2006-184770

(51) Int. Cl. A62B 7/08

(52) U.S. Cl. 422/105; 422/123

(57) ABSTRACT

When it is determined that a driver is extremely-concentrating, a fragrance emitted by a relaxing air freshener is intermittently released by emitting. To quickly reduce the tension of the driver, a long fragrance emit period is set, while a short fragrance emit stopped period is set. When it is determined that the driver is randomly scanning, the amount of the relaxing air freshener discharged is smaller than that when the driver is extremely-concentrating, and a shorter fragrance emit period is set, while a longer fragrance emit stopped period is set. As a result, an aroma that is so faint that the driver may not notice is used to maintain the random scanning state, and further, a fragrance emitted by an awakening air freshener is emitted, as needed, near the nose of the driver.

### CROSS REFERENCE TO RELATED APPLICATIONS

The disclosure of Japanese Application No. 2006-184770 filed on Jul. 4, 2006 including the specification, drawings, and abstract is incorporated herein by reference in its entirety.

### BACKGROUND OF THE INVENTION

1. Field of the Invention

The present invention relates to a driving support system that emits a fragrance inside a vehicle to promote, for a driver, the maintenance of an appropriate state for a driving environment.

2. Related Art

As a driving support apparatus for a vehicle, one has been developed, and has been put to practical use, that applies a technique involving the use of a vehicular mounted camera for detecting the driving environment to the front of a moving vehicle. This driving support apparatus performs tracing or warning control, based on the driving environment, relative to the space to the front of the moving vehicle, and generates a warning when an obstacle is detected in the path ahead.

Further, studies have also recently been performed to evaluate effects produced when various fragrances were introduced into the interior of a vehicle.

For example, in JP-A-06-255358, a technique is disclosed that involves the emission, by a fragrance apparatus, of various types of fragrances that effectively promote wakefulness, and to directionally alter and adjust forced air streams to propel these fragrances towards a driver in order to prevent the driver from dozing off at the wheel.

As disclosed in JP-A-06-255358, according to the conventional art, a fragrance intended to maintain driver's alertness is introduced into a vehicle, to keep a driver from dozing off while driving. However, even when the driver is alert, the state of the driver may differ. That is, in accordance with the conventional technique, emitting of a fragrance is not performed to change the state of a driver from one wherein the driver is concentrating only on one object to the front, such as a forward moving vehicle in the path ahead, to a state wherein the driver is concentrating not only on the vehicle to the front but is also acutely aware of all that is occurring in the immediate vicinity, and to maintain this altered state.

Therefore, it is difficult, according to the conventional art, for a driver state to be maintained that appropriately satisfies the requirements of the driving environment.

### SUMMARY OF THE INVENTION

One or more embodiments of the invention provide a driving support system that emits a fragrance appropriate to the state of a driver, so that a driver state consonant with the driving environment can be maintained.

In accordance with one or more embodiments of the invention, a driving support system using fragrance emitting is provided with:

a fragrance generator, for emitting a fragrance inside a vehicle;

a driver state determination unit, for determining whether the state of a driver of the vehicle is a extremely-concentrating state, indicating the driver is concentrating only on one object to the front, or a random scanning state, indicating the driver is attentively aware of conditions in the immediate vicinity of the vehicle; and

a controller, for controlling, in accordance with the state of the driver, as determined by the driver determination unit, the emitting of the fragrance inside the vehicle to maintain the random scanning state or to shift the state of the driver from the extremely-concentrating state to the random scanning state.

According to one or more embodiments of the invention, the driving support system using fragrance emitting releases a fragrance in consonance with the state of a driver, to maintain a driver state that is appropriate to the driving environment.

Other aspects and advantages of the invention will be apparent from the following description and the appended claims.

### BRIEF DESCRIPTION OF THE DRAWINGS

FIG. 1 is a diagram showing the basic configuration of a driving support system according to a first exemplary embodiment of the invention.

FIG. 2 is a diagram for explaining a variance in line-of-sight behavior for a front field of vision and a front, moving vehicle according to the first exemplary embodiment.

FIG. 3 is a diagram for explaining an example of attentiveness evaluation value according to the first exemplary embodiment.

FIG. 4 is a diagram for explaining fragrance emitting positions according to the first exemplary embodiment.

FIG. 5 is a flowchart for the driver state determination processing according to the first exemplary embodiment.

FIG. 6 is a flowchart for the fragrance emitting control processing according to the first exemplary embodiment.

FIGS. 7A to 7C are explanatory diagrams showing examples fragrance emitting timing according to the first exemplary embodiment.

FIG. 8 is a flowchart for the driver state determination processing according to a second exemplary embodiment of the invention.

FIG. 9 is a flowchart for the fragrance emitting control processing according to the second exemplary embodiment.

### DETAILED DESCRIPTION OF THE EXEMPLARY EMBODIMENTS

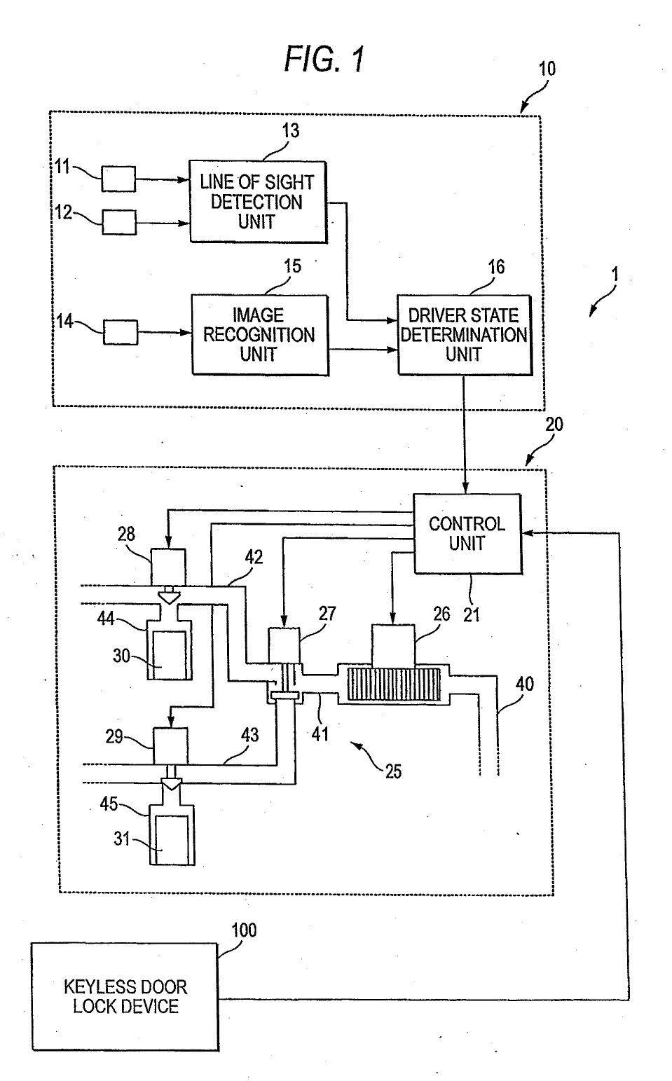

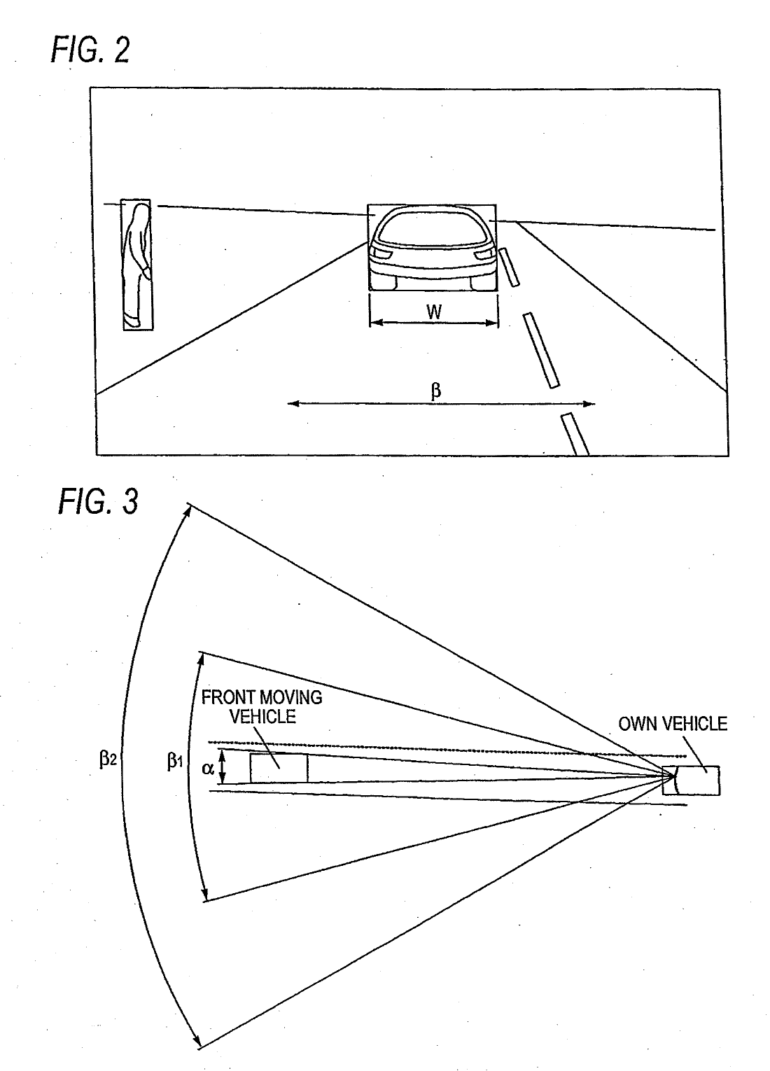

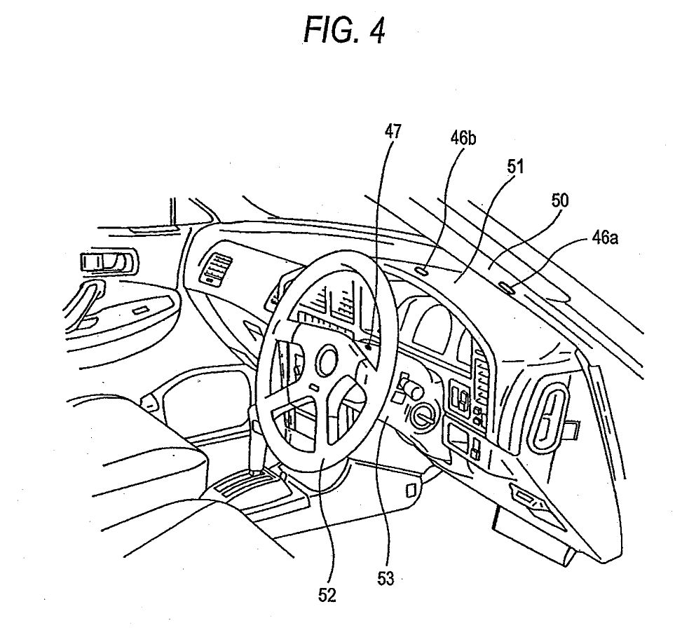

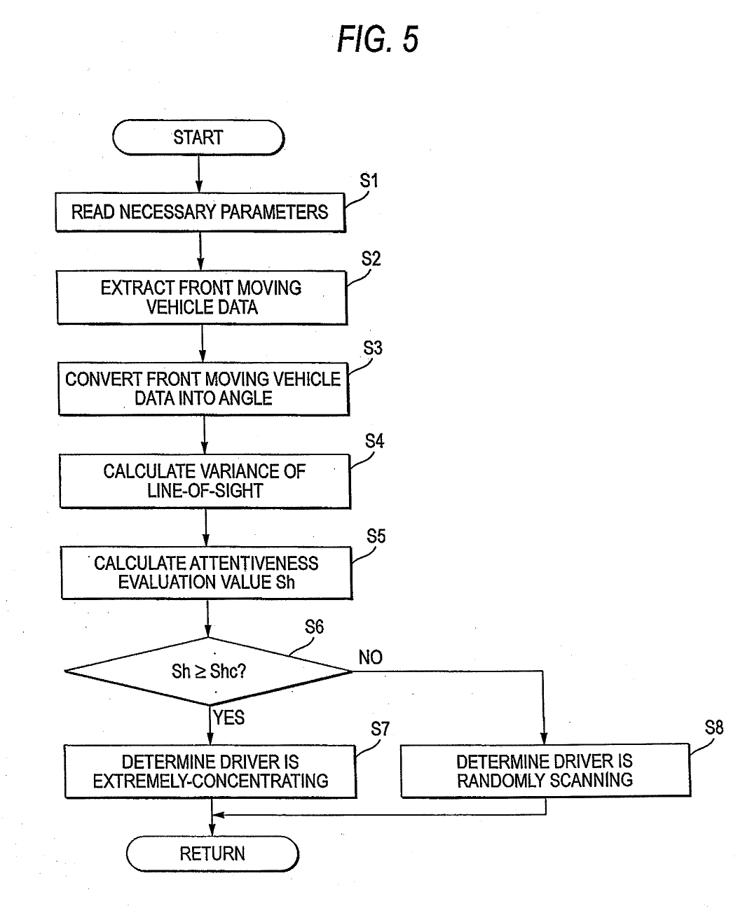

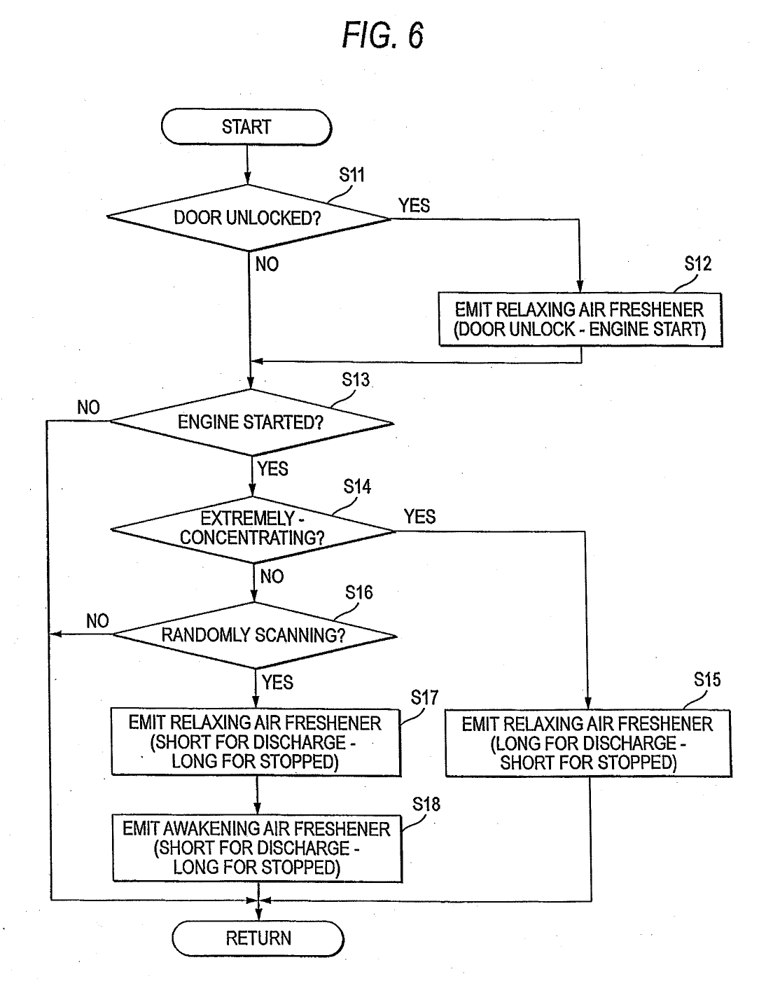

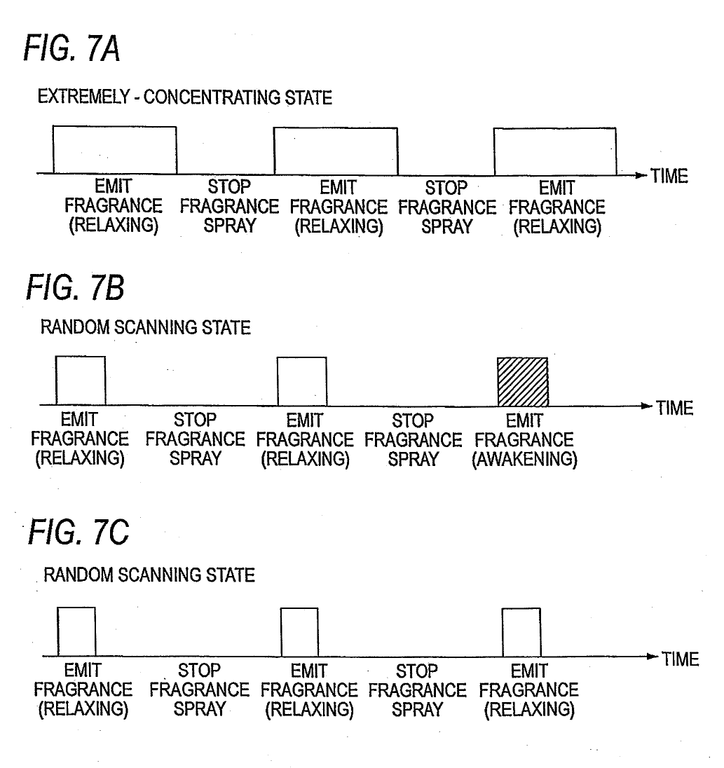

Exemplary embodiments of the invention will now be described while referring to the drawings. FIGS. 1 to 7 are related to a first exemplary embodiment of the invention. That is, FIG. 1 is a diagram showing the basic configuration of a driving support system. FIG. 2 is a diagram for explaining variances in the line-of-sight behavior in the forward range of vision and the width of a front, moving vehicle. FIG. 3 is a diagram for explaining example of attentiveness evaluation values. FIG. 4 is an explanatory diagram showing a fragrance emitting position. FIG. 5 is a flowchart for the driver state determination processing. FIG. 6 is a flowchart for fragrance emit control processing. And FIGS. 7A to 7C are charts for explaining example fragrance emit timings.

A driving support system 1 in FIG. 1 emits a fragrance inside a vehicle, such as an automobile, and supports driving, so that the condition of a driver is appropriate to the driving environment. This driving support system 1 is mainly provided with: a driver state estimation device 10 for assuming the state of a driver; and a fragrance generation device 20 for emitting a fragrance that is emitted by a predetermined air freshener.

In the first exemplary embodiment, the driver state estimation device 10 estimates that a driver is either extremely-concentrating which indicates a driver is in a high degree of tension, or is randomly scanning which indicates the driver is adapting to the driving environment. Further, an attentiveness evaluation value Sh is employed as an evaluation value to determine whether the driver is either extremely-concentrating or randomly scanning. As will be explained later, the attentiveness evaluation value Sh is calculated based on the line-of-sight behavior of a driver, which is detected by a camera, and image recognition to the front, outside a vehicle, which are obtained by a camera or a laser radar.

Specifically, by detecting the line-of-sight behavior of the driver using the camera, the direction in which the driver is looking while driving can be identified, and when a relationship between an object to the front, outside the vehicle, which is detected by image recognition, and eye movement relative to this object is obtained, the state of a driver is determined to be either “extremely-concentrating”, indicating that the driver is tensely concentrating on an object to the front, or “randomly scanning”, indicating that while adapting to the driving environment the driver is not only watching an object to the front but is peripherally viewing, and is attentively aware of, conditions within the entire surrounding area, not just the object to the front.

Specifically, the driver state estimation device 10 includes: a visual field camera 11, which captures the eye movements of a driver; an infrared lamp 12; a line-of-sight detection unit 13, for detecting the line of sight of a driver using the visual field camera 11 and the infrared lamp 12; an external monitoring camera 14, which captures, the scene outside and to the front a vehicle; an image recognition unit 15, which processes a signal received from the external monitoring camera 14; and a driver state determination unit 16, which determines the state of a driver based on the information for the line-of-sight behavior of the driver, detected by the line-of-sight detection unit 13, and on the information obtained by the image recognition unit 15 for the scene outside and to the front of the vehicle.

In the first embodiment, a so-called pupillary/corneal reflex method is employed to detect the line-of-sight behavior of the driver, the visual field camera 11 is, for example, a camera that includes an infrared CCD, and the infrared lamp 12 is, for example, an LED lamp. Furthermore, in this embodiment, a stereo camera, which includes a pair of cameras arranged at a predetermined interval, is employed as the external monitoring camera 14, and in order to obtain the situation outside the vehicle, stereo image processing is performed for an object (a three-dimensional object) outside the vehicle that is picked up by this stereo camera.

For the detection of the line-of-sight behavior by the line-of-sight detection unit 13, due to differences in the rotation centers of a cornea and an eyeball, a virtual image formed by the infrared lamp 12 on a cornea is moved parallel in accordance with the movement of an eye, and the visual field camera 11 detects this parallel movement, using the center of a pupil as a reference, while detecting the center of the pupil at the same time. The detection method for the line-of-sight behavior is not limited to this method, and if available, another method may be employed, such as the EOG (Electro-Oculography), the scleral reflex method, the corneal reflex method or the search coil method.

For a pair of stereo images to the front of a possessing vehicle obtained by the external monitoring camera 14, which is a stereo camera, the image recognition unit 15 obtains distance information using the principle of a triangular survey performed based on a difference in corresponding positions, and generates a distance image that represents a 3D distance distribution.

Then, based on data for the distance image, the image recognition unit 15 performs the known group processing, compares the resultant data with frames (windows) that are stored in advance, such as 3D road form data, side wall data and 3D object data, and extracts white line data, side wall data for guard rails and curbs existing along roads, and 3D object data for vehicles.

Different numbers are provided for these white line data, the side wall data and the 3D object data. In addition, in accordance with a relationship between a change in the distance from the possessing vehicle and the vehicular velocity of the possessing vehicle, the 3D object data is classified into a stationary object and a forward moving object that is moving substantially in the same direction as the possessing vehicle.

For example, of the forward moving objects that are sequentially detected in the travel region of the possessing vehicle over a predetermined period of time, the 3D object nearest the possessed object is registered as a front, moving vehicle. In the first exemplary embodiment, information for this front, moving vehicle is output to the driver state determination unit 16 as information for recognition outside the vehicle that is compared with the line-of-sight behavior of the driver.

The driver state determination unit 16 determines the state of a driver based on the information for the line-of-sight behavior detected by the line-of-sight detection unit 13, and information for the front, moving vehicle detected by the image recognition unit 15. At this time, as shown in FIG. 2, since the width information for the front, moving vehicle is provided as the unit of length (W in FIG. 2) by the image recognition unit 15, and the line-of-sight behavior of the driver is provided as the unit of angle, as shown in FIG. 3, the width W of the front, moving vehicle is converted into a value α, which is the unit of angle, in order to perform the calculations. This conversion is performed by using the following expression (1).

α=2·arctan((W/2)/L) (1)

Further, a variance β, indicating the horizontal variance of the line-of-sight behavior relative to the front, moving vehicle, is calculated using information for the line-of-sight behavior of the driver. That is, an eye focal point on a virtual plane is calculated based on the rotation angle of the eyes, and when the horizontal element of the viewing point is denoted as xⱼ, the horizontal variance β of the eye focal point over a specific time span [t₁, t₂] (e.g., 30 to 60 seconds) is calculated by using the following expression (2).

$$β = ( 1 / ( {t}_{2} - {t}_{1} + 1 ) ) \cdot {\sum }_{j = t 1}^{t 2} ( {x}_{j}^{2} - {x}_{a}^{2} ) \qquad ( 2 )$$

In this case, xa is the average value, and is calculated by using the following expression (3).

$${x}_{a} = ( 1 / ( {t}_{2} - {t}_{1} + 1 ) ) \cdot {\sum }_{j = t 1}^{t 2} {x}_{j} \qquad ( 3 )$$

As shown in expression (4) below, a standard deviation sₓ may also be employed as a value indicating the variance in the line-of-sight behavior relative to the front, moving vehicle.

$${s}_{x} = {( ( 1 / n ) \cdot {\sum }_{j = t 1}^{t 2} ( {x}_{j}^{2} - {x}_{a}^{2} ) )}^{1 / 2} \qquad ( 4 )$$

The ratio of the width a of the front, moving vehicle to the variance β of the line-of-sight of the driver is calculated as the attentiveness evaluation value Sh (Sh=α/β), which represents the level of attentiveness, and the state of a driver is determined by comparing the attentiveness evaluation value Sh with a predesignated evaluation threshold value Shc. When the attentiveness evaluation value Sh is equal to or greater than the evaluation threshold value Shc (e.g., 0.1) (e.g., the case of a state β1 in FIG. 3), it is determined that the state of the driver is extremely-concentrating, which indicates that the attention given by a driver to a front, moving vehicle is strong, and the tension of the driver is high. When the attentiveness evaluation value Sh is smaller than the evaluation threshold value Shc (e.g., the case of a state β2 in FIG. 3), it is determined that the state of the driver is randomly scanning, which indicates the attention given by a driver to a front, moving vehicle is not more than is necessary, and the driver can adapt to a driving environment.

In the exemplary embodiment, the width W of the front, moving vehicle has been converted to the angle to calculate the attentiveness evaluation value Sh. However, the variance β of the line-of-sight behavior of the driver may be converted to the length at the position of the front, moving vehicle to calculate the attentiveness evaluation value Sh.

The fragrance generation device 20 mainly includes a control unit 21 that controls a fragrance emitting mechanism 25 for emitting, inside a vehicle, a fragrance emitted by an air freshener. At the time a door lock is released by the reception of a keyless unlock signal from a keyless door lock device 100, or in accordance with the driver state received from the driver state determination unit 16, the control unit 21 permits the fragrance emitting mechanism 25 to emit a predetermined fragrance inside the vehicle. In this embodiment, a relaxing air freshener 30 having an orange aroma has a soothing effect on a driver's nerves and an awakening air freshener 31 having a mint aroma that has and awakening effect are prepared. The relaxing air freshener 30 is mainly employed, and as needed, the awakening air freshener 31 is employed.

The fragrance emitting mechanism 25 is a blowing system wherein a blowing fan 26 is arranged inside a dashboard, for example, in the front of a vehicle compartment, and using the blowing fan 26, air is introduced to an air freshener through a selector valve 27 and switching valves 28 and 29, so that a fragrance is sent forth to the inside of the vehicle. An intake passage 40 for the blowing fan 26 is opened at a predetermined portion of the compartment, e.g., at the foot of the passenger seat, and a blowoff passage 41 for the blowing fan 26 is branched to ventilation ducts 42 and 43 by the selector valve 27. A perfume container 44 holding the relaxing air freshener 30 and a perfume container 45 holding the awakening air freshener 31 are respectively located along the ventilation ducts 42 and 43, and these containers 44 and 45 are opened or closed by the switching valves 28 and 29, respectively.

The indoor blowoff ports for the ventilation duct 42 are opened at positions such that the vehicle compartment can be faintly filled with the aroma of the relaxing air freshener 30 and the driver can be effectively relaxed. For example, as shown in FIG. 4, as fragrance blowoff ports for the relaxing air freshener 30, an opening 46a and an opening 46b are respectively formed in an A pillar 50 on the driver side and in the upper portion of a meter visor 51. On the other hand, the indoor blowoff port for the ventilation duct 43 is opened at a position such that the aroma of the awakening air freshener 31 is emitted directly into the face of a driver, especially near the nose, in order to actually awaken the driver. For example, as shown in FIG. 4, as the fragrance blowoff port for the awakening air freshener 31, an opening 47 is formed in the upper portion of a column cover 53 that is the base of a steering wheel 52.

It should be noted that the fragrance emitting mechanism 25 may be formed as part of an air conditioning system for a vehicle.

The control unit 21 generally maintains a state wherein the perfume container 45 in which the awakening air freshener 31 is stored is closed by the switching valve 29, and the ventilation duct 43 is closed by the selector valve 27. When the control unit 21 detects the door lock has been released by the reception of a keyless unlock signal from the keyless door locking device 100, the control unit 21 determines an occupant has boarded the vehicle. Then, the control unit 21 opens the switching valve 28 over a predetermined period of time, and drives the blowing fan 26 to blow air to the ventilation duct 42, so that a fragrance having a relaxing effect is generated from the relaxing air freshener 30 stored in the perfume container 44. As a result, the fragrance spreads through the opening 46a of the A pillar 50 and the opening 46b in the upper portion of the meter visor 51, so as to carry the fragrance faintly distributed in the air.

Further, when it is determined during driving that the driver is extremely-concentrating, the control unit 21 cyclically opens or closes the switching valve 28, and cyclically extends the valve opening period to increase the amount (emitted fragrance amount) of the relaxing air freshener 30 that is discharged. Thus, the tension of the driver is quickly reduced, and the state of the driver is shifted to randomly scanning.

When the driver state has been shifted to randomly scanning, the control unit 21 shortens the valve opening period for the switching valve 28 and reduces the amount of the relaxing air freshener 30 discharged to maintain the random scanning state of the driver.

In addition, during the processing for reducing the amount of the relaxing air freshener 30 discharged to maintain random scanning, the control unit 21 opens, as needed, the switching valve 29 for the perfume container 45, where the awakening air freshener 31 is stored, and blows air through the ventilation duct 43 by changing the selector valve 27. In this manner, the awakening air freshener 31 is continuously discharged.

That is, when time has elapsed from the start of driving, the state of the driver adapts to the driving environment, and is shifted to randomly scanning, which indicates the tension is reduced subconsciously. However, when the tension of the driver is reduced too much, the driver would become drowsy, which indicates that the reduced alertness. Therefore, when the condition of the driver is randomly scanning, not, only a relaxing fragrance is intermittently emitted, but also an awakening fragrance. In this manner, the driver is kept from shifting from randomly scanning to drowsy, and the random scanning condition can be stably maintained.

The operation of the driving support system 1 is performed by the program processing in FIGS. 5 and 6. This program processing will now be described.

The driver state estimation processing performed by the driver state estimation device 10 is shown in the flowchart in FIG. 5. First, a necessary parameter is read at step S1.

Program control advances to step S2, and an image obtained by the external monitoring camera 14 is processed to extract a front, moving vehicle, and at step S3, width information for the front, moving vehicle is converted into an angle α.

Program control advances to step S4, and the average value of the line-of-sight behavior of the driver and the variance β consonant with this average value are calculated. At step S5, the ratio of the width a of the front running vehicle to the variance β of the line-of-sight behavior of the driver is calculated as the attentiveness evaluation value Sh representing the attentive state (Sh=α/β). At step S6, the attentiveness evaluation value Sh is compared with the predesignated evaluation threshold value Shc.

As a result, when the attentiveness evaluation value Sh is equal to or greater than the evaluation threshold value Shc, program control advances to step S7, and it is determined that the state of the driver is extremely-concentrating, which indicates the attention given to the front, moving vehicle is strong. Then, program control exits this processing. When the attentiveness evaluation value Sh is smaller than the evaluation threshold value Shc, program control is shifted to step S8, and it is determined that the driver is in the state (randomly scanning) indicating attention given to the front running car is not strong. Thereafter, program control exits this processing.

The results of the determination of the driver state are referred to in the fragrance emitting control processing shown in the flowchart in FIG. 6.

The fragrance emitting control processing is the processing performed by the control unit 21 of the fragrance generation device 20. First, at step S11, the control unit 21 determines whether the door lock has been released by the reception of a keyless unlock signal.

When the door lock has not been released, program control advances from step S11 to step S13. When the door lock has been released, it is determined that an occupant has boarded the vehicle, program control is shifted from step S11 to S12 and the control unit 21 opens the switching valve 28 for the perfume container 44, where the relaxing air freshener 30 is stored, and drives the blowing fan 26. Program control then is shifted to step S13.

At this time, through an action performed by the selector valve 27, the blowoff passage of the blowing fan 26 communicates with the ventilation duct 42 for the relaxing air freshener 30, and the ventilation duct 43 for the awakening air freshener 31 is closed.

As a result, a fragrance generated from the relaxing air freshener 30 is emitted inside the vehicle compartment, from the opening 46a of the A pillar 50 and from the opening 46b of the upper portion of the meter visor 51. The period for emitting the fragrance of the relaxing air freshener 30 in the compartment is designated, for example, as a period from the time the door lock is released to the start of the engine, and the opening of the switching valve 28 and the air flow rate of the blowing fan 26 are set so that a faint aroma of the fragrance that has a relaxing effect released.

At step S13, the control unit 21 determines whether the engine has been started. When the engine has not yet been started, it is assumed that the vehicle is at a stop, with the doors closed, or is in the state existing before the engine starts following the release of the door lock. Therefore, program control exits the processing while the current status is maintained. When the engine has been started, program control advances to step S14 where the control unit 21 reads the results obtained by the driver state estimation unit 10, through the driver state estimation processing, and determines whether, during driving, the driver has become extremely-concentrating.

When it is determined that the driver is extremely-concentrating, program control is shifted from step S14 to step S15, and the control unit 21 employs the switching valve 28 and the blowing fan 26 to emit the fragrance of the relaxing air freshener 30 through the opening 46a of the A pillar 50 and the opening 46b of the meter visor 51. Thereafter, program control exits this processing. The amount of the relaxing air freshener 30 (emitted amount of the fragrance) to be discharged for the extremely-concentrating driver should be adjusted to an amount that will quickly reduce the tension of the driver. That is, as shown in FIG. 7A, mainly the discharge of a fragrance and stopping of the discharge are cyclically repeated by intermittently opening or closing the switching valve 28, and the valve open period (fragrance emitting period) during the cycle is relatively long while the valve closed period (fragrance discharge stopped period) is short.

On the other hand, when it is determined at step S14 that the driver is not extremely-concentrating, program control advances from step S14 to step S16, and the control unit determines whether the driver is randomly scanning. When it is determined that the driver is not randomly scanning, program control exits the processing while the current state is maintained. When the driver is randomly scanning, program control advances to step S17.

At step S17, the switching valve 28 and the blowing fan 26 are employed to discharge the fragrance of the relaxing air freshener 30 through the opening 46a of the A pillar 50 and the opening 46b in the upper portion of the meter visor 51. The amount of the relaxing air freshener 30 to be discharged for the randomly scanning driver should be adjusted to smaller than the amount discharged for the extremely-concentrating driver, in order to maintain the random scanning state. That is, the valve open period (fragrance emitting period) of the switching valve 29 in the cycle is long, while the valve closed period (fragrance discharge stopped period) is short, and the fragrance discharged is so faint that the driver may not notice it.

Sequentially, program control advances to step S18, and temporarily, the control unit 21 employs the selector valve 27 to change the blowoff passage of the blowing fan 26 to the ventilation duct 43 for the awakening air freshener 31, opens the switching valve 29, and emits the fragrance of the awakening air freshener 31 through the opening 47 formed in the upper portion of the column cover 53, which is the base of the steering wheel 52. As the amount of the awakening air freshener 31 (the emitted amount of the fragrance) discharged for the randomly scanning driver, the fragrance spaying interval is set longer than that for the relaxing air freshener 30 for maintaining the random scanning condition. That is, as shown in FIG. 7B, the fragrance of the awakening air freshener 31 is emitted, on and off, near the nose of the driver, and a reduction in the alertness of the driver can be prevented.

In this case, the timing for emitting of the fragrance of the awakening air freshener 31 can be determined based, for example, on a warning for zigzag driving. As is well known (see, for example, JP-A-2002-154345 or JP-A-2005-71184), a zigzag driving warning is generated by estimating the alertness level of a driver based on the frequency component of the transverse displacement of a vehicle. To prevent a reduction in the alertness of a driver, awakening effect fragrance need only be generated from the awakening air freshener 31 and be discharged into the compartment for a predetermined period (e.g., 60 seconds) by employing the occurrence of a zigzag driving warning as a reference time, and for a predetermined period (e.g., 30 seconds) employing, as a reference, the vicinity of a threshold value of the primary zigzag driving warning, or during a predetermined period (e.g., 60 seconds) employing, as a reference, the vicinity of the threshold value of the secondary zigzag driving warning.

Further, more simply, the process at step S18 may be eliminated, and the amount of the relaxing air freshener 30 discharged may be adjusted, so that the random scanning condition of the driver can be maintained without employing the awakening air freshener 31. That is, to prevent shifting from randomly scanning to drowsy, as shown in FIG. 7C, a shorter period than that in FIG. 7B is set for emitting of the relaxing air freshener 30, or the discharge interval is extended. When the awakening air freshener 31 is not employed, the structure of the fragrance emitting mechanism 25 can be simplified, and the system cost can be reduced.

As described above, in the first exemplary embodiment, when the line-of-sight behavior of a driver is employed to determine that the driver is extremely-concentrating, which indicates high tension, a fragrance that has a relaxing effect is emitted into the compartment of a vehicle to reduce the tension of the driver, and to quickly shift from extremely-concentrating to randomly scanning. Therefore, the driving support system supports the driver and assists the driver in adapting to the driving environment, and helps in the improvement of safety.

When the driver is randomly scanning, a fragrance that has relaxing effect is faintly distributed within the compartment to maintain random scanning. Further, since the fragrance that has an awakening effect is discharged, as needed, a reduction in alertness can be prevented and the random scanning state can be steadily maintained. Thus, the driving support system supports the optimization of the driving state.

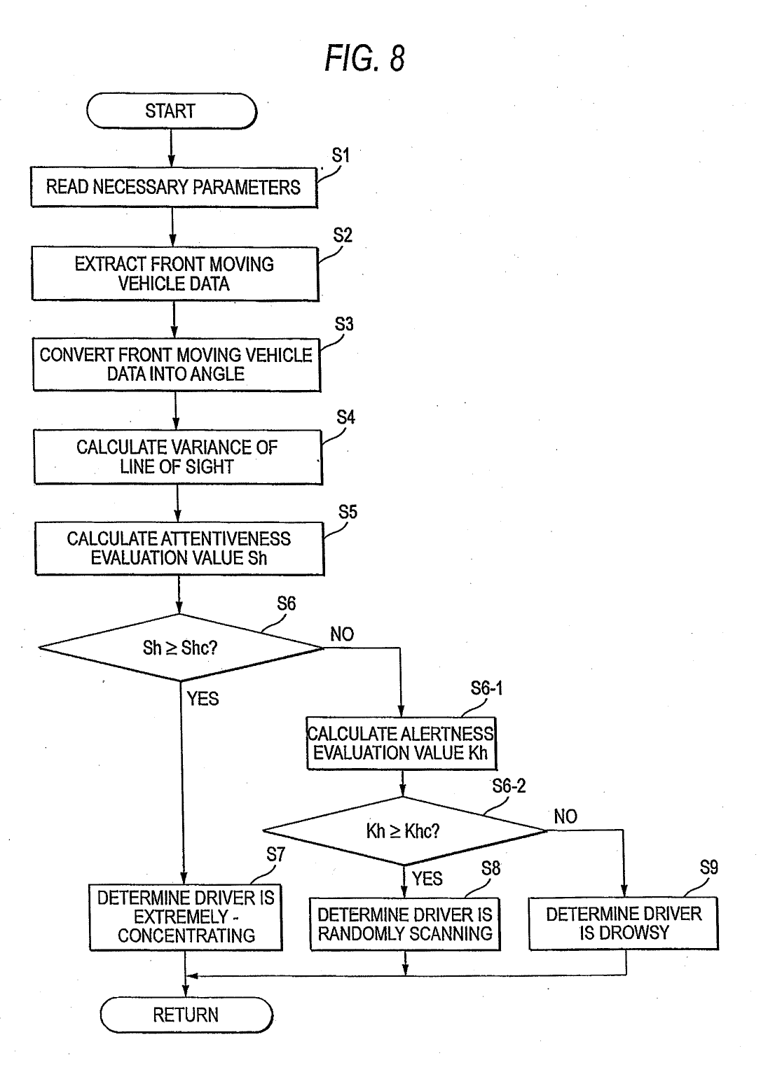

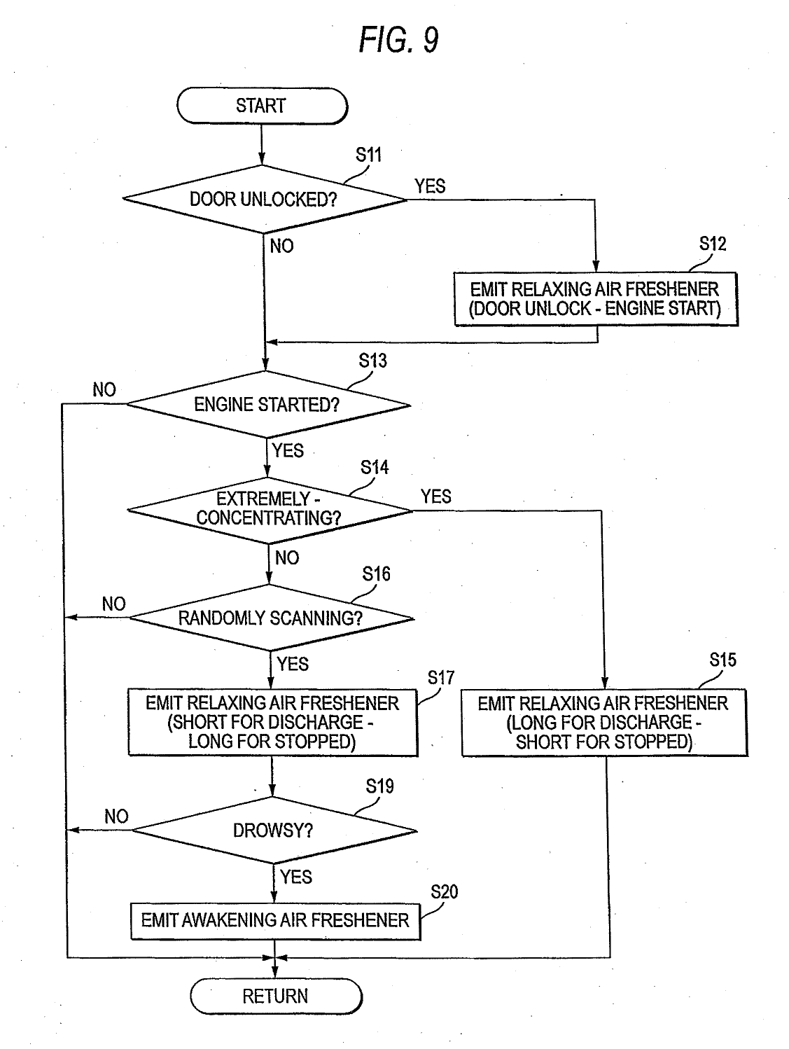

A second exemplary embodiment of the invention will now be described. FIGS. 8 and 9 relate to the second exemplary embodiment of the invention, i.e., FIG. 8 is a flowchart for the driver state determination processing and FIG. 9 is a flowchart for the fragrance emit control processing.

In the first exemplary embodiment, when the driver is randomly scanning, the awakening air freshener 31 is discharged, as needed, in order to prevent a reduction in the tension of the driver and a change to drowsy. According to the second exemplary embodiment, whether the driver is shifted from randomly scanning to drowsy is determined, and the discharge of the awakening air freshener 31 is controlled in accordance with the determination results.

That is, according to the second exemplary embodiment, the driver state determination processing in FIG. 8, which is a more detailed processing than that in FIG. 5 for the first exemplary embodiment, is performed to determine more driver states, i.e., extremely-concentrating, randomly scanning and drowsy.

In the driver state determination processing in FIG. 8 for the second exemplary embodiment, processes at steps S6-1 and S6-2 for determining whether a driver is drowsy are additionally provided for the processing in FIG. 6, when, at step S6, the driver is randomly scanning and not extremely-concentrating, i.e., the attentiveness evaluation value Sh is smaller than the evaluation threshold value Shc.

Specifically, at step S6-1, an alertness evaluation value Kh, indicating the alertness level of a driver, is calculated using expression (5), for example, and at step S6-2, is compared with a predesignated threshold value Khc. When the alertness evaluation value Kh is equal to or greater than the threshold value Khc, program control is shifted from step S6-2 to step S8, and it is determined that the driver is randomly scanning.

When the alertness evaluation value Kh is smaller than the threshold value Khc, program control advances from step S6-2 to step S9, and it is determined that the driver is in the drowsy state.

Kh={(number of times eyes closed longer than a blink)/(the total number of blinks)} (5)

For evaluation of alertness, instead of the alertness evaluation value Kh using expression (5), the vehicle driving condition of a driver (the manipulation of a steering wheel) may be referred to. That is, when the driver is alert, vehicle movements are generated with a high frequency and a small amplitude, while when the driver is drowsy, fluctuations occur with a low frequency and a large amplitude. This vehicle movement may also be referred to for the evaluation of alertness.

In the fragrance emitting control processing in FIG. 9 for the second exemplary embodiment, when the random scanning state is obtained through a determination performed in the same manner as in the first exemplary embodiment (see in FIG. 6), and when, at step S17, the relaxing air freshener 30 is discharged, program control advances to step S19 to determine whether the driver is drowsy.

When it is determined that the driver is not drowsy, program control exits the processing, while the state of the relaxing air freshener 30 discharged in the randomly scanning condition is maintained. When it is determined that the driver is drowsy, program control advances to step S20. The process at step S20 corresponds to step S18 in the fragrance emitting control processing of the first exemplary embodiment. In the same manner as in the first exemplary embodiment, a selector valve 27 is employed to change the blowoff passage of a blowing fan 26 to a ventilation duct 43 for the awakening air freshener 31, and a switching valve 29 is opened to emit the awakening air freshener 31 through an opening 47, which is formed in the upper portion of a column cover 53 at the base of a steering wheel 52. The same amount of the awakening air freshener 31 as in the first exemplary embodiment may be discharged. However, since it has been determined that the driver is drowsy, it is preferable that a slightly larger amount be discharged to quickly avoid a reduction in alertness.

According to the second exemplary embodiment, the driver in the random scanning state is examined based on the line-of-sight behavior and the driving condition, and when it is determined that the driver is drowsy, a fragrance having an awakening effect is discharged into the compartment of a vehicle. Therefore, the driving support system can more effectively prevent a reduction in the alertness of the driver, and can increase driving safety.

1-4. (canceled)

5. A method for using a fragrance-emitting system for a driving support system, wherein the fragrance-emitting system includes a first fragrance generator to emit a relaxing fragrance comprising:
determining whether a driver's state is in an extremely concentrating state indicating that the driver is fixedly concentrating on an object in front of a vehicle, or a random scan state indicating that the driver is fully attentive to conditions in a vicinity of the vehicle; and
permitting the first fragrance generator to shorten an emitting period for the relaxing fragrance so as to maintain the driver's random scanning, state, when the driver's state is in the random scanning state.

6. The method for using the fragrance-emitting system according to claim 5, further comprising:
permitting a second fragrance generator to emit an awakening fragrance, when the driver's state is in the random scanning state.

7. The method for using the fragrance-emitting system according to claim 6, further comprising:
determining whether the driver is drowsy, when the driver's state is in the random scanning state, and
permitting the second fragrance generator to emit the awakening fragrance to a nose of the driver.
